(19) United States
(12) Patent Application Publication
(10) Pub. No.: US 2008/0222043 A1
(43) Pub. Date: Sep. 11, 2008

(54) SYSTEM AND METHOD FOR TRANS-VENDOR LICENSE REGISTRATION AND RECOVERY

(76) Inventors: Thomas Edward Chefalas, Somers, NY (US); Steven J. Mastrianni, Unionville, CT (US); Clifford Alan Pickover, Yorktown Heights, NY (US)

Correspondence Address: DUKE W. YEE, YEE & ASSOCIATES, P.C., P.O. BOX 802333, DALLAS, TX, 75380, US

(21) Appl. No.: 11/683,159

(22) Filed: Mar. 7, 2007

(51) Int. Cl. H04L 9/32

(52) U.S. Cl. 705/59

(57) ABSTRACT

Computer implemented method, system and computer usable program code for recovering application software in a data processing system. A computer implemented method for recovering application software in a data processing system includes receiving user data and application data from a plurality of users over a computer network, wherein the application data relates to application software of the plurality of users and includes application license data for applications that include a license. The received user data and application data are stored. A request is received over the computer network from a user of the plurality of users to recover application software of the user, and the requested application software is provided to the user over the computer network, wherein the provided application software is enabled and configured based on the user data and application data related to the provided application software.

### BACKGROUND OF THE INVENTION

1. Field of the Invention:

The present invention relates generally to the data processing field and, more particularly, to a computer implemented method, system and computer usable program code for recovering application software in a data processing system.

2. Description of the Related Art:

It is an unfortunate fact that computer systems occasionally crash and need to be rebuilt. There are, in fact, many reasons that may require restoring a computer system's contents and work environment including, for example, when spyware has made the computer system unusable and the operating system must be reloaded, or when the HDD (Hard Disk Drive) fails or a registry becomes corrupt.

When a computer system needs to be restored, whether by a service or directly by an end-user of the system, application software must often be reinstalled in the system, and this can present significant problems in that the end-user may not have ready access to the software and to license keys that may be needed to reinstall the software.

There is, accordingly, a need for a mechanism that facilitates the recovery of application software in a computer system in connection with restoration of the computer system and for other reasons.

### SUMMARY OF THE INVENTION

Exemplary embodiments provide a computer implemented method, system and computer usable program code for recovering application software in a data processing system. A computer implemented method for recovering application software in a data processing system includes receiving user data and application data from a plurality of users over a computer network, wherein the application data relates to application software of the plurality of users and includes application license data for applications that include a license. The received user data and application data are stored. A request is received over the computer network from a user of the plurality of users to recover application software of the user, and the requested application software is provided to the user over the computer network, wherein the provided application software is enabled and configured based on the user data and application data related to the provided application software.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 is a pictorial representation of a network of data processing systems in which exemplary embodiments may be implemented;

FIG. 2 a block diagram of a data processing system in which exemplary embodiments may be implemented;

FIG. 3 is a block diagram of an application software recovery system according to an exemplary embodiment;

FIG. 4 is a diagram that schematically illustrates storage of user data and application data for a plurality of applications according to an exemplary embodiment; and

FIG. 5 is a flowchart that illustrates a method for recovering application software according to an exemplary embodiment.

### DETAILED DESCRIPTION OF THE PREFERRED EMBODIMENT

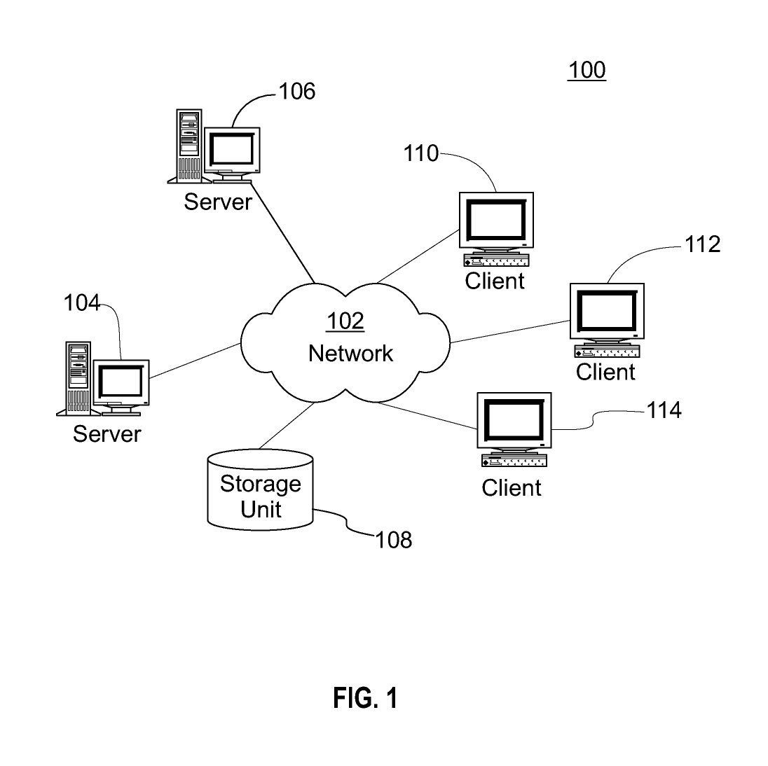

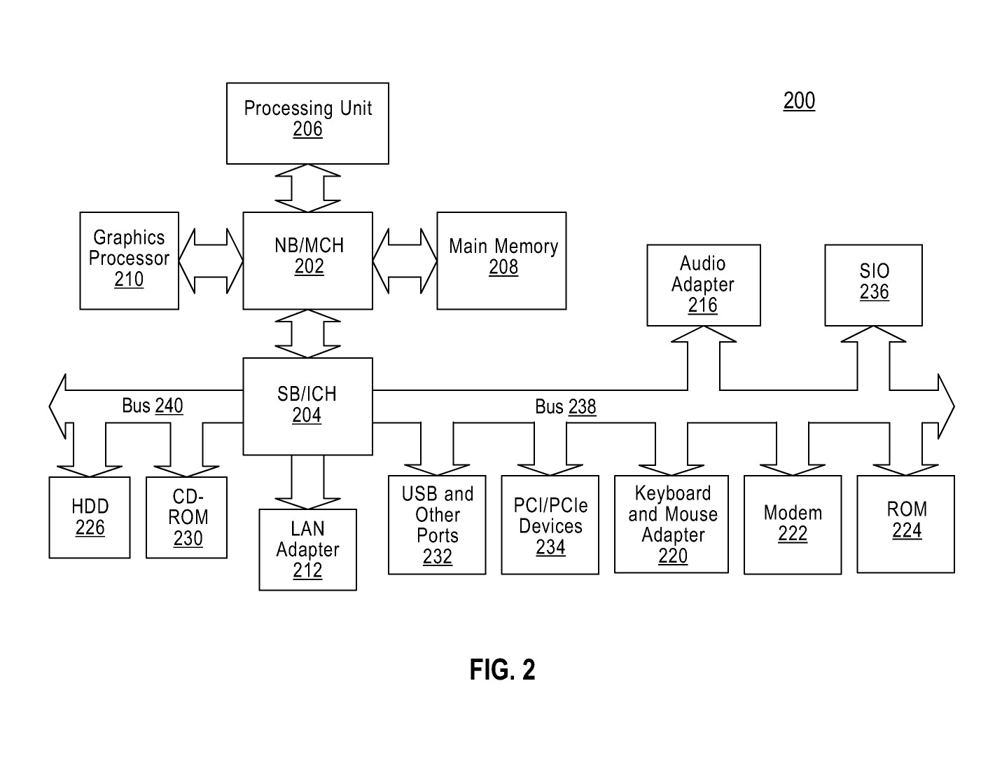

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which exemplary embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide a computer implemented method, system and computer usable program code for recovering application software in a data processing system. In accordance with an exemplary embodiment, a trans-vendor license registration service (TVLRS) is provided by which a plurality of user computer systems may register their application software with appropriate license keys, user settings and other information. When a user computer system must be rebuilt, for example, due to spyware, hard disk drive (HDD) problems, registry corruption or the like; the application software may be legally and properly recovered because the TVLRS will contain all the proper keys and other information needed to recover the application software for the user.

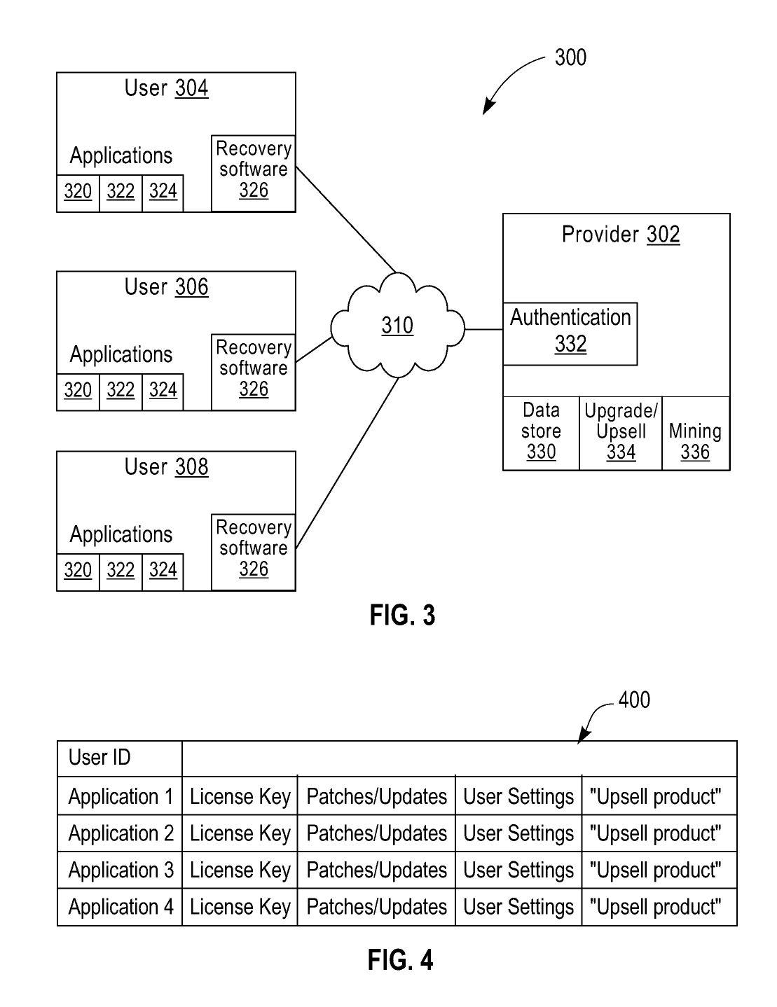

FIG. 3 is a block diagram of an application software recovery system according to an exemplary embodiment. The system is generally designated by reference number 300, and includes a TVLRS provider 302, often referred to herein as application software recovery service provider 302, and a plurality of user computer systems 304, 306 and 308, often referred to herein as users 304, 306 and 308. Users 304, 306 and 308 are computer systems of customers/clients which have contracted to receive application software recovery services from application software recovery service provider 302.

Application software recovery service provider 302 may be implemented as one of servers 104 and 106 in FIG. 1, and users 304, 306 and 308 may be implemented as one of clients 110, 112 and 114, respectively, in FIG. 1 or as data processing system 200 in FIG. 2.

As shown in FIG. 3, users 304, 306 and 308 are connected to provider 302 via computer network 310 which may be implemented as network 102 in FIG. 1 and is typically the Internet. It should be understood that although three users are illustrated in FIG. 3, in practice, application software recovery service provider 302 may provide recovery services for any desired number of users.

Each user 304, 306 and 308 includes one or more installed software applications. In FIG. 3, each user is shown as having three applications 320, 322 and 324 installed; however, this is intended to be exemplary only as each user may have any desired number of applications installed, any of which may be the same as or different from applications installed by other users. The applications may have been “preinstalled”, or they may have been installed at a later time.

Each user 304, 306 and 308 also includes installed application recovery software 326. Application recovery software 326 may also have been preinstalled, or it may have been installed at a later time. Application recovery software 326 may have been obtained from provider 302 or from a third party, and enables users 304, 306 and 308 to communicate with and utilize the services of application software recovery service provider 302.

As will be explained more fully hereinafter, when one of users 304, 306 and 308 completes installation of an application, for example, one of applications 320, 322 and 324, it notifies provider 302 via computer network 310 and sends user identification data and application data to provider 302 to be stored in data store 330. Data store 330 is preferably a local persistent data store although it should be understood that the data can be stored in any appropriate manner and at any desired location without departing from exemplary embodiments. Provider 302 also includes an authentication mechanism 332 to verify the authenticity of a user requesting recovery services; and, optionally, upgrade/upsell mechanism 334 for upgrading or replacing or for offering to upgrade or replace a user application, and data mining mechanism 336 for gathering marketing and sales information regarding users and products.

Application software recovery service provider 302 maintains, in data store 330, all necessary data regarding each user 304, 306 and 308, and its respective application software 320, 322 and 324 that is needed to enable the application software to be legally and properly restored. FIG. 4 is a diagram that schematically illustrates storage of user data and application data for a plurality of applications for one user according to an exemplary embodiment. As shown, the data may be stored in a table, generally designated by reference number 400, and includes user identification data 402 needed to authenticate the user, and for each registered application, all data needed to recover the application including, license keys 404 (for allowing applications that include licenses to be reinstalled as licensed applications), updates and/or patches 406 made to the application, any customizations and settings 408 with respect to the application, including, for example, user settings, user customizations (such as file paths, margins, fonts, etc.) and operating system specific settings related to the application, such as the amount of virtual memory it requires and the type of device or devices that are required to support the application (which is important if the application is restored to a new machine) and upsell product information 410. A separate table 400 is maintained for each user, and each table is capable of being updated as users install new applications or change existing applications.

Consider that a customer/client, for example, a company or an individual, purchases a user computer system. The computer system comes with an operating system and several applications preinstalled on the system's hard disk. When the user computer system is started, the customer/client is presented with end-user license agreements (EULAs) for the operating system and for each preinstalled application. The customer/client configures each application with the required and desired settings. In the process of configuring each application, the application usually contacts a server at the manufacturer to verify the license and authorize its use.

When all applications have been configured as indicated above, application recovery software 326 in the user computer system is invoked. When invoked, application recovery software 326 enumerates the list of programs that have been installed and validated for the user. It then contacts application software recovery service provider 302 via computer network 310 and sends user identification data and application data regarding each installed application to provider 302. According to an exemplary embodiment, the user identification data may include one or more of name of the customer/client (e.g., individual and/or company name), user address, password, phone number, e-mail address, computer MAC address and the like. The application data includes a list of the installed applications, and, as indicated previously, may include license keys relating to the applications, patches/updates made to the applications, user settings and/or customizations and operating system specific settings. Application data may also include various types of auxiliary data files, for example, a user dictionary or special fonts for a word processor, clip art for a presentation program, and sound files or model geometry files for a graphics or games program.

Provider 302 utilizes its own internal knowledge of the applications to determine which settings to retrieve from the user system and how to retrieve them. Provider 302 then contacts the user via recovery software 326 which sends the data to provider 302 via computer network 310. Preferably, recovery software 326 encrypts the data before it is sent over network 310. For example, fairly secure systems may store each password in a cryptographically protected form, so access to the actual password will be difficult for a spy who gains access to the system, while validation still remains possible. A common cryptographically-based scheme stores a “hashed” form of the plaintext password. The hash value is created by applying a cryptographic hash function to a string consisting of the submitted password. MD5 and SHAL are frequently used cryptographic hash functions. Provider 302 saves the transmitted data in data store 330 until needed.

Application recovery software 326 can be invoked whenever a new application is installed or whenever an existing application has been modified. In this way, software application recovery service provider 302 is able to act as a broker on behalf of software manufacturers while, at the same time, providing a valuable recovery service for the user.

In particular, if a user experiences a major failure such as a hard disk crash, the customer/client reloads application recovery software 326 into the affected user computer system. Application recovery software 326 then contacts provider 302 via network 310. The user logs on to the provider and enters appropriate credentials. When the user has been authenticated, provider 302 sends the application software to the user via computer network 310 to be installed. The application software is enabled and configured based on the stored user and application data related to the provided application software. Depending on the type of restoration, the data sent by the provider may be a disk image, a portion of a disk image or a single program or piece of data. The sent data is decrypted by application recovery software 326 before being installed.

When provider 302 is contacted to restore a user's application software, it will check the version of the user's application with the application's current level. If the user application is outdated or requires updating, provider 302 may optionally perform an upgrade of the application or offer to sell the customer a new or replacement application as indicated by upgrade/upsell mechanism 334. Specifically, when a user system is being rebuilt, provider 302 can attempt to entice the customer/client to pay an extra fee to upgrade the application software to the most current version, i.e., to buy other software versions, other features, etc.

Application software recovery service provider 302 maintains an inventory of all applications of all users that subscribe to the recovery service. This information is optionally mined using data mining mechanism 336 to provide targeted marketing and sales information that may be sold for a fee to manufacturers or other interested third parties.

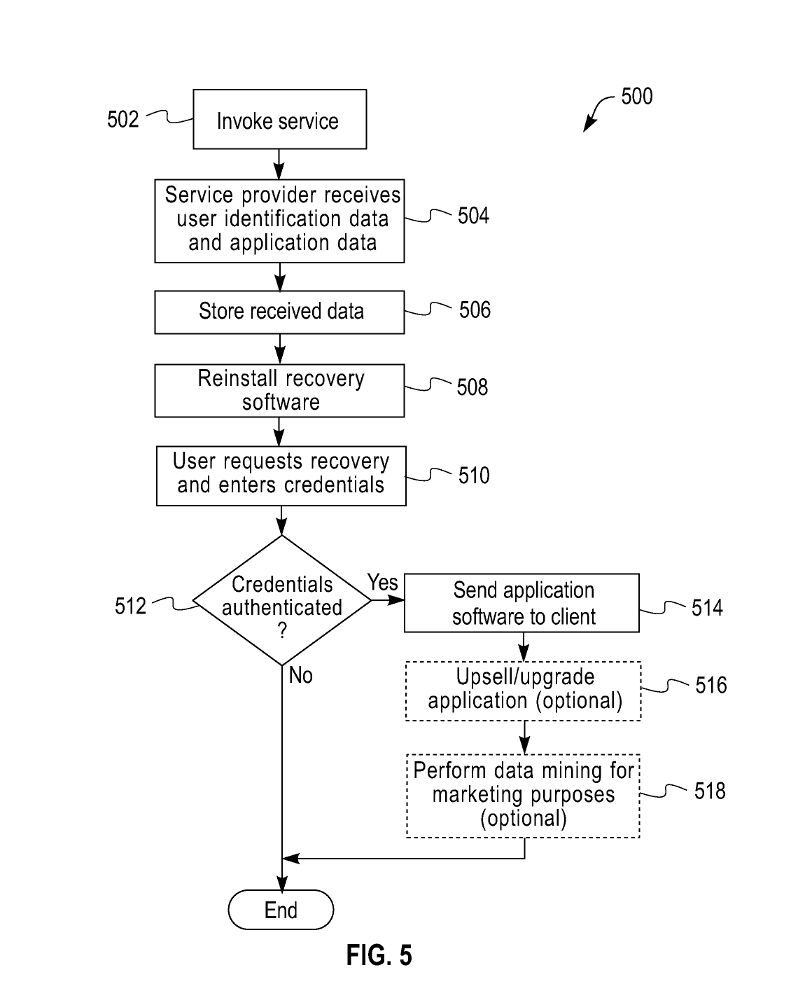

FIG. 5 is a flowchart that illustrates a method for recovering application software according to an exemplary embodiment. The method is generally designated by reference number 500, and begins by a user computer system invoking an application software recovery service via installed application recovery software (Step 502). The service may be invoked in connection with initial set up of the user computer system, i.e., when configuring applications that have been preinstalled on the user's hard drive with required or desired settings; or at a later time when a new application is installed or when an existing application has been modified.

The application recovery software then contacts the application software recovery service provider and sends the recovery service provider user identification data and, for each application of the user that is to be protected by the recovery service, any application data that is pertinent to recovering the application (Step 504). Preferably, the information is sent over a computer network in encrypted form. The received user identification data and application data is stored by the provider, for example, in a local persistent data store (Step 506).

If, at some time in the future, the user computer system experiences a major failure such as a hard disk crash, the application recovery software is reinstalled in the user, if necessary (Step 508), and the recovery service provider is contacted via the application recovery software. In particular, the user logs onto the recovery service provider and enters its credentials (Step 510). The recovery service provider authenticates the credentials (Step 512). If the user credentials are authenticated (Yes output of Step 512), the recovery service provider sends the requested application software to the user to be installed (Step 514). The application software is enabled and configured based on the stored user and application data related to the provided application software. Depending on the type of restoration required, the data may be a disk image, a portion of a disk image or a piece of data. Recovery of the application may also require an online activation in order to reauthorize use of the application.

If the user credentials are not authenticated (No output of Step 512), no recovery action is taken by the recovery service provider and the method ends.

When the recovery service provider is contacted to restore user application software, the provider may optionally perform upgrades to user applications or sell or offer to sell new or replacement applications to the customer/client of the user computer system (Step 516). In particular, the recovery service provider may check the version of the user's applications and determine if newer version are available. If so, the provider can either automatically furnish the upgraded versions to the user or offer the user an opportunity to purchase new or replacement applications.

For example, during this upgrade process, the customer/client may be notified about the advantages of upgrading, which may include new features associated with the application, a more robust or stable application, or a more secure application. In this manner, the customer/client is able to make a more informed decision about the upgrade and also may be more likely to request such an upgrade. Sometimes, a particular vendor of an application may have gone out of business or may no longer be participating in the upgrade process for other reasons. In such cases, the original application may still be offered; however, alternative applications with similar features may be offered as well. For example, the customer/client may be notified about a related graphics program that he may install if the original graphics program can no longer be upgraded.

According to a further exemplary embodiment, the recovery service provider can utilize the data it has collected and stored regarding its customers/clients and users applications for marketing purposes (Step 518). In this regard, the provider has stored an inventory of user applications from a plurality of users, and thus has knowledge of the needs and business environments of its customers/clients. The recovery service provider can periodically mine this stored information to provide targeted marketing and sales information which can be sold to manufacturers or other third parties for a fee.

Exemplary embodiments thus provide a computer implemented method, system and computer usable program code for recovering application software in a data processing system. A computer implemented method for recovering application software in a data processing system includes receiving user data and application data from a plurality of users over a computer network, wherein the application data relates to application software of the plurality of users and includes application license data for applications that include a license. The received user data and application data are stored. A request is received over the computer network from a user of the plurality of users to recover application software of the user, and the requested application software is provided to the user over the computer network, wherein the provided application software is enabled and configured based on the user data and application data related to the provided application software.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for recovering application software in a data processing system, the computer implemented method comprising:
receiving user data and application data from a plurality of users over a computer network, wherein the application data relates to application software of the plurality of users and includes application license data for applications that include a license;
storing the received user data and application data;
receiving a request over the computer network from a user of the plurality of users to recover application software of the user; and
providing the requested application software to the user over the computer network, wherein the provided application software is enabled and configured based on the user data and application data related to the provided application software.

2. The computer implemented method according to claim 1, and further comprising:
authenticating the user before providing the requested application software to the user.

3. The computer implemented method according to claim 1, wherein the application data further comprises at least one of user settings data, user customization data, operating system specific settings data, auxiliary file data, and patches/updates to applications.

4. The computer implemented method according to claim 3, wherein the auxiliary file data comprises at least one of a user dictionary, special fonts, clip art, sound files and model geometry files.

5. The computer implemented method according to claim 1, wherein the user data comprises user identification data.

6. The computer implemented method according to claim 1, and further comprising:
encrypting the user data and application data from the plurality of users before receiving the user data and application data over the network.

7. The computer implemented method according to claim 1, and further comprising:
notifying the user regarding one or more available upgrades relating to the requested application software.

8. The computer implemented method according to claim 7, wherein notifying the user regarding one or more available upgrades relating to the requested application software, comprises:
notifying the user regarding an available alternate application.

9. The computer implemented method according to claim 1, and further comprising:
providing an upgrade of the requested application software to the user.

10. The computer implemented method according to claim 1, and further comprising:
mining the stored user data and application data for providing sales information regarding the plurality of users.

11. A computer program product, comprising:
a computer usable medium having computer usable program code for recovering application software in a data processing system, the computer program product comprising:
computer usable program code configured for receiving user data and application data from a plurality of users over a computer network, wherein the application data relates to application software of the plurality of users and includes application license data for applications that include a license;
computer usable program code configured for storing the received user data and application data;
computer usable program code configured for receiving a request over the computer network from a user of the plurality of users to recover application software of the user; and
computer usable program code configured for providing the requested application software to the user over the computer network, wherein the provided application software is enabled and configured based on the user data and application data related to the provided application software.

12. The computer program product according to claim 11, and further comprising:
computer usable program code configured for authenticating the user before providing the requested application software to the user.

13. The computer program product according to claim 11, wherein the application data further comprises at least one of user settings data, user customization data, operating system specific settings data, auxiliary file data, and patches/updates to applications; and wherein the user data comprises user identification data.

14. The computer program product according to claim 11, and further comprising:
computer usable program code configured for encrypting the user data and application data from the plurality of users before receiving the user data and application data over the network.

15. The computer program product according to claim 11, and further comprising:
computer usable program code configured for at least one of notifying the user regarding one or more available upgrades regarding the requested application software, and mining the stored user data and application data for providing sales information regarding the plurality of users.

16. An application software recovery system for recovering application software in a data processing system, comprising:
an application software recovery service provider for receiving user data and application data from a plurality of users over a computer network, wherein the application data relates to application software of the plurality of users and includes application license data for applications that include a license, and wherein the application software recovery service provider includes:
a data store for storing the received user data and application data;
an input mechanism for receiving a request over the computer network from a user of the plurality of users to recover application software of the user; and
an output mechanism for providing the requested application software to the user over the computer network, wherein the provided application software is enabled and configured based on the user data and application data related to the provided application software.

17. The application software recovery system according to claim 16, wherein the input mechanism comprises an authentication mechanism for authenticating the user before providing the requested application software to the user.

18. The application software recovery system according to claim 16, wherein the application data further comprises at least one of user settings data, user customization data, operating system specific settings data, auxiliary file data, and patches/updates to applications, and wherein the user data comprises user identification data.

19. The application software recovery system according to claim 16, and further comprising at least one of a mechanism for notifying the user regarding one or more available upgrades regarding the requested application software, and a mechanism for mining the stored user data and application data for providing sales information regarding the plurality of users.

20. The application software recovery system according to claim 16, and further comprising application recovery software installed in each of the plurality of users for enabling communication with the application software recovery service provider.
